(19) United States
(12) Patent Application Publication
(10) Pub. No.: US 2009/0058810 A1
(43) Pub. Date: Mar. 5, 2009

(54) INPUT DEVICE AND IMAGING DEVICE HAVING THE SAME

(76) Inventor: Yasunobu Kikuchi, Tokyo (JP)

Correspondence Address: David A. Novais, Patent Legal Staff;Eastman Kodak Company, 343 State Street, Rochester, NY, 14650-2201, US

(21) Appl. No.: 12/040,125

(22) Filed: Feb. 29, 2008

(30) Foreign Application Priority Data
Sep. 5, 2007 (JP) 2007-229802

(51) Int. Cl. G06F 3/02

(52) U.S. Cl. 345/168

(57) ABSTRACT

In a keyboard displayed on a display, a desired character or symbol is efficiently input. A string field section, a key section, and an option section are displayed on a rear LCD, or the like, of a digital camera. A neutral key is provided in the option section. When a cursor is moved from the option section to the key section, operation means is operated with the cursor being situated at the neutral key, whereby the cursor is moved to the key section. After a character or a symbol has been selected by the option section, the cursor is automatically return to the neutral key.

### CROSS REFERENCE TO RELATED APPLICATIONS

This application claims priority to Japanese Patent Application No. 2007-229802 filed on Sep. 5, 2007, which is incorporated herein by reference in its entirety.

### FIELD OF THE INVENTION

The present invention relates to an input device and an imaging device having the same, and more particularly to a device which inputs characters, or the like, by displaying a keyboard on a screen.

### BACKGROUND OF THE INVENTION

When characters are input by means of portable electronic equipment, such as a digital camera, proposed processing is to provide a touch panel on the back of the equipment and to sequentially input characters, or to display a keyboard on the rear LCD by means of software processing and select a key on the keyboard by operation of a cursor, thereby sequentially inputting characters. However, a method which enables a user to efficiently and reliably input characters at a limited screen size is desired.

Japanese application No. 2001-429982001-42998A describes a portable processing device aimed at easily, quickly completing selecting operation by means of operation for displaying a menu screen through use of a JOG dial key and operating a choice, thereby returning to an idle state. A choice for commanding completion of selecting operation is provided in choices displayed on a selection screen. By means of selecting the choice, the processing device terminates selecting operation, to thus return an idle state; i.e., a standby condition.

Japanese application No. 2002-111839A describes a multifunctional portable information terminal aimed at enhancing ease of input operation while maintaining miniaturization of a device. The publication discloses, in a hierarchical structure having a top menu, sub-menus, and setting lists, a configuration including selecting a setting list by means of an inner cursor key, displaying a sub-menu of one higher level as a lateral tabulation and selecting any item by means of right and left keys of an outer cursor; displaying a plurality of items in the form of a longitudinal tabulation when a selection list includes the plurality of items and selecting any one item by means of up and down keys of the outer cursor key.

Japanese application No. 10-155020A describes, for the sake of implementing a communications terminal device having superior operability, rotating an operator while detailed information about items is being displayed, thereby restoring a state where a plurality of items of one higher level are displayed.

However, none of the related-art techniques provide a technique which enables sequential input of arbitrary characters by means of efficient, simple operation when a keyboard is displayed on a screen.

The present invention is intended to provide a device which displays a keyboard on a screen and which efficiently, easily enables sequential input of desired characters or symbols by use of a cursor.

### SUMMARY OF THE INVENTION

The present invention provides an input device comprising:

a display having a first display section for displaying, in accordance with a first layout, a group of keys assigned a plurality of characters or symbols and a second display section for displaying, in accordance with a second layout, a group of optional keys which are each assigned one of the plurality of characters or symbols allocated to one arbitrary key of the group of keys;

operation means that can be operated by a user; and

control means for moving and displaying a cursor within the first display section or the second display section in accordance with an operation signal from the operation means, wherein
the second display section displays, in the group of optional keys, a neutral key not assigned the character or the symbol; and

the control means receives the operation signal from the operation means with the cursor being situated at the neutral key and moves and displays the cursor from the second display section to and on the first display section.

In one embodiment of the present invention, when an optional key other than the neural key of the second display section is selected in accordance with the operation signal from the operation means, the control means moves and displays the cursor from the selected optional key to and on the neutral key.

In another embodiment of the present invention, when the cursor is moved and shown from an arbitrary key of the first display section to the second display section in accordance with the operation signal from the operation means, the control means moves and displays the cursor to and on the neutral key.

According to the present invention, the cursor is smoothly moved between the first display section and the second display section by provision of the neutral key, and a desired character or symbol can be input efficiently and reliably.

The invention will be more clearly comprehended by reference to the embodiment provided below. However, the scope of the invention is not limited to the embodiment.

### BRIEF DESCRIPTION OF THE DRAWINGS

A preferred embodiment of the present invention will be described in detail by reference to the following drawings, wherein:

FIG. 1 is a block diagram of a digital camera of an embodiment;

FIG. 2 is a rear view of the digital camera of the embodiment;

FIG. 3 is a view (PART 1) for describing a keyboard display of the embodiment;

FIG. 4 is a view (PART 2) for describing a keyboard display of the embodiment;

FIG. 5 is a view (PART 3) for describing a keyboard display of the embodiment;

FIG. 6 is a view (PART 4) for describing a keyboard display of the embodiment;

FIG. 7 is a view (PART 5) for describing a keyboard display of the embodiment;

FIG. 8 is a view (PART 6) for describing a keyboard display of the embodiment;

FIG. 9 is a view (PART 7) for describing a keyboard display of the embodiment; and

FIG. 10 is a processing flowchart of the embodiment.

### DETAILED DESCRIPTION OF THE INVENTION

An embodiment of the present invention will be described hereunder by reference to the drawings and by means of taking a digital camera as an example.

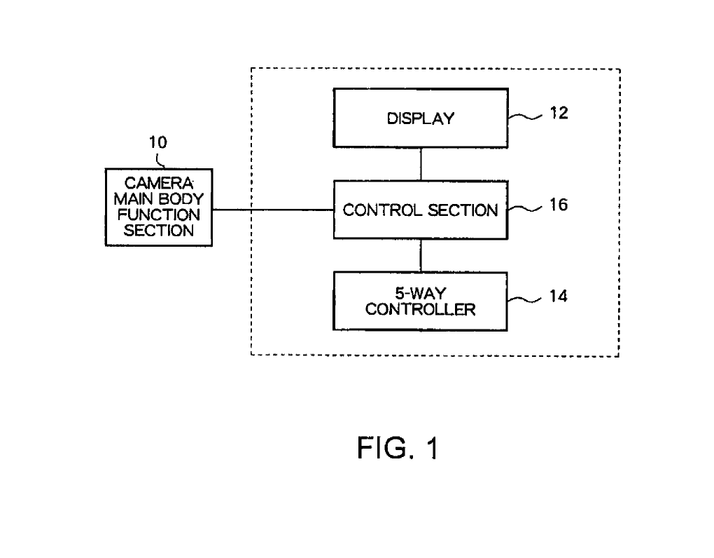

FIG. 1 shows a block diagram of an overall digital camera of the present embodiment. In addition to having a function section 10 of a camera main body, the digital camera has a display 12, a 5-way controller 14, and a control section 16.

The function section 10 of the camera main body has an optical system required to capture an image and a processing circuit for processing captured image data. Specifically, the function section has a CCD that converts light reflected from a subject into an electric signal and that outputs the electric signal as an analogue image signal; an analogue front end (AFE) that subjects an analogue image signal to correlated double sampling, to thus convert the analogue image signal into a digital image signal; an image processing IC; and an external storage medium. The image processing IC subjects the digital image signal to YC separation, thereby providing the signal with various processing such as edge enhancement processing, white balance adjustment, color correction processing, and γ correction processing. The thus-processed captured image data are stored after being compressed in a JPEG format and further stored in an external recording medium such as flash memory. The captured image recorded in the external recording medium is decoded and displayed on the rear LCD, or the like, of the digital camera. The image processing IC may also have a camera shake correction function. For instance, the amount of camera shake due to hand movements is detected in accordance with angular velocity detected by a gyroscopic sensor, and PSF used for correcting the amount of camera shake is computed. Camera shake correction may also be performed by mechanically actuating a portion of an objective lens, or camera shake correction may further be performed by mechanically actuating a CCD.

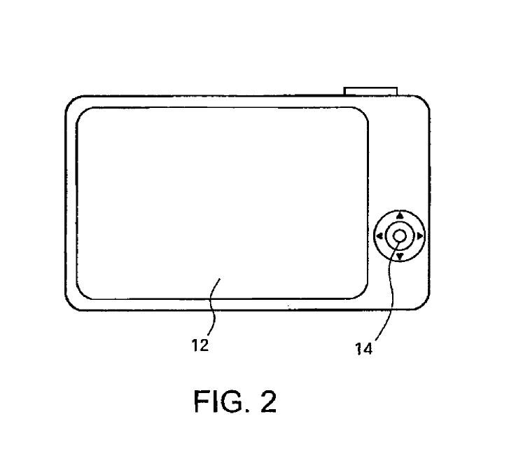

The display 12 provided on the back of the digital camera shows an image formed on the CCD or a captured image recorded in an external recording medium. Moreover, the display shows a keyboard when characters are input as in the case of addition of a title or a comment to a captured image. The control section 16 controls the layout of the keyboard and a cursor display which are displayed on the display 12. The 5-way controller 14 is a controller or a key switch which is provided in the vicinity of the display 12 and which can be manually actuated by the user; namely, a controller which can be operated independently in four direction—up, down, right, and left—and which enables depressing of a center section (an OK button). The control section 16 is supplied with an operation signal conforming to the direction of operation of the 5-way controller 14; that is, operations achieved in a total of five directions consisting of operations achieved in four directions (up, down, right, and left) and operation (depression of the center section) achieved in one direction. In accordance with the direction of operation, the control section 16 moves and displays a cursor, thereby determining a selected character or symbol data. The control section 16 has a microprocessor and working memory, displays a keyboard (software keyboard) on the display 12 in accordance with a program stored in ROM; and displays a cursor used for selecting each of the keys. The cursor is displayed by means of highlighting or blinking a selected key. A captured image and a screen for setting various parameters of the camera also appear on the display 12. The control section 16 displays the keyboard on the display 12 when the camera shifts to a character input mode as a result of a mode changeover switch (not shown) provided on the digital camera being actuated. FIG. 2 shows an example of the display 12 provided on the back of the digital camera and an example of the 5-way controller 14. The display 12 has a size of, for example, 2.5 inches, and is built from an image display device such as an LCD or an organic EL.

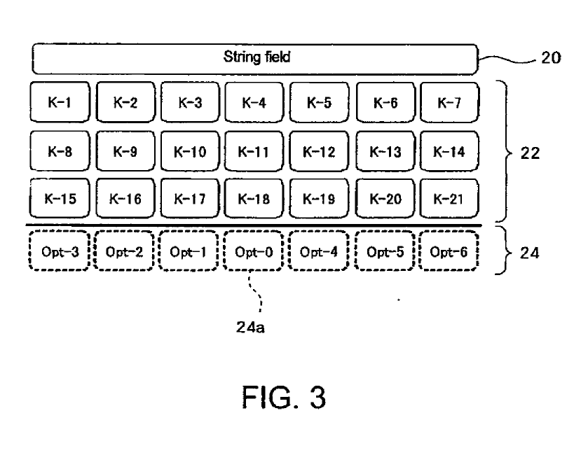

The keyboard on the display 12, which is controlled and displayed by the control section 16, will be described hereinbelow. FIG. 3 shows the basic configuration of the keyboard (a software keyboard) displayed on the display 12. A string field section 20, a key section 22 serving as a first display section, and an option section 24 serving as a second display section are displayed. The key section 22 and the option section 24 assume a hierarchical structure, and the option section 24 corresponds to a display section which is lower than the key section 22 by one level.

The string field 20 is a field where a selected input key is displayed. The key section 22 is displayed below the sing field section 20, and keys are displayed in a matrix pattern. In the drawing a total of 21 keys from K-1 to K-21 are displayed in a matrix pattern from the upper left to the lower right. Specific characters or symbols (including numerics) are assigned to the respective keys. In order to select a desired key from the keys constituting the key section 22, the 5-way controller 14 is used. When the 5-way controller 14 is actuated up, down, right, or left, the cursor actuates the key section 22 up, down, right, or left in accordance with the direction of operation. For instance, when the 5-way controller 14 is actuated rightwards while the cursor is situated at the K-1 key, the cursor is moved rightwards, to thus sequentially move from the K-1 key, a K-2 key, and a K-3 key. Moreover, when the 5-way controller 14 is actuated downwardly, the cursor moves downwardly, to thus move in sequence from the K-1 key, a K-8 key, and a K-15 key. When the 5-way controller 14 is actuated downwardly while the cursor has already moved to the K-15 key, the cursor again returns to the K-1 key, to thus make a round.

The option section 24 is displayed below the key section 22. The option section 24 is formed from keys which are identical in number to horizontal keys of the key section 22, and is displayed in a row. In the drawing, the key section 22 is formed from seven keys arranged in the horizontal direction, and the option section 24 is also formed from seven keys arranged in the horizontal direction. The option section 24 can also be said to be arranged in a matrix pattern with one row and seven columns. The seven keys are, in sequence from the left, opt-3, opt-2, opt-1, opt-0, opt-4, opt-5, and opt-6, and specific characters or symbols are assigned to the respective keys. However, a center key 24a (opt-0) is a neutral key, and neither a character nor a symbol is assigned to that key. The key shows the position of the cursor when the cursor shifts between the key section 22 and the option section 24. Namely, when the cursor moves from the key section 22 to the option section 24, the position of the key 24a is the initial position at all times, and the cursor moves left or right from this position. Even when the cursor returns from the option section 24 to the key section 22, the cursor always returns from the position of the key 24a to the key section 22. When the cursor is situated at a position other than the position of the key 24a, the cursor does not move from the option section 24 to the key section 22.

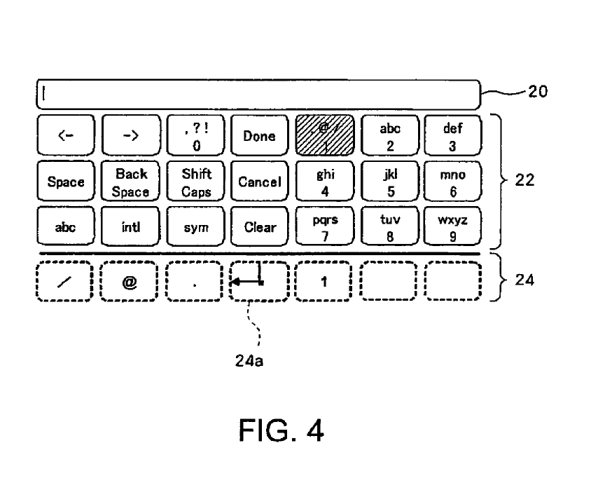

FIG. 4 shows an example case where the key section 22 and the option section 24 are assigned characters. In the key section 22, the K-1 key is assigned a left arrow key; the K-2 key is assigned a right arrow key, the K-3 key is assigned “0” or “?”; and the K-6 key is assigned characters of the alphabet “abc” or “2.” Optional characters are assigned to the option section 24 in response to the respective keys of the key section 22. In FIG. 4, in response to the cursor situated at the K-5 key, “/,” “@,” “.,” and “1,” which are optional characters of the K-5 key, are assigned to the opt-3, the opt-2, the opt-1, and the opt-4. The key 24a serving as a neutral key is not assigned a character.

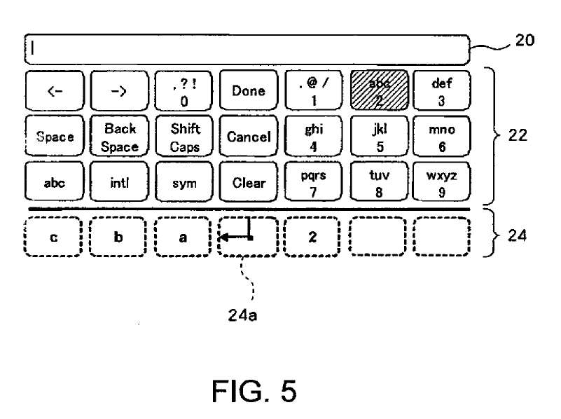

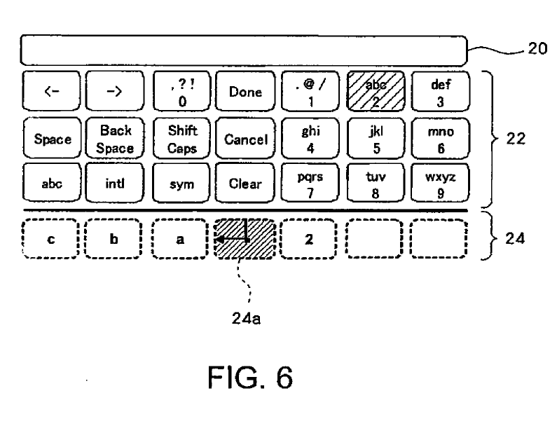

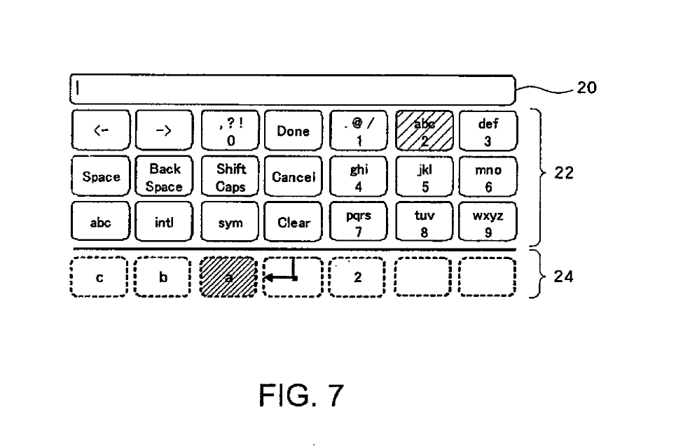

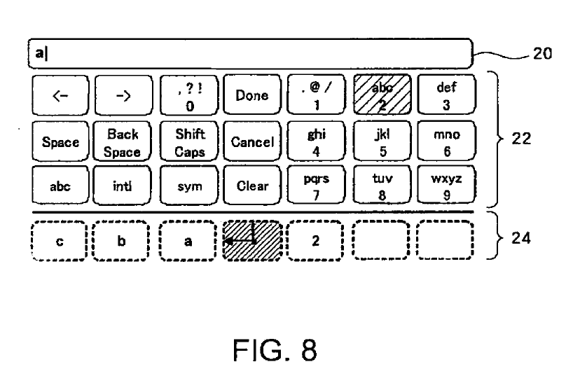

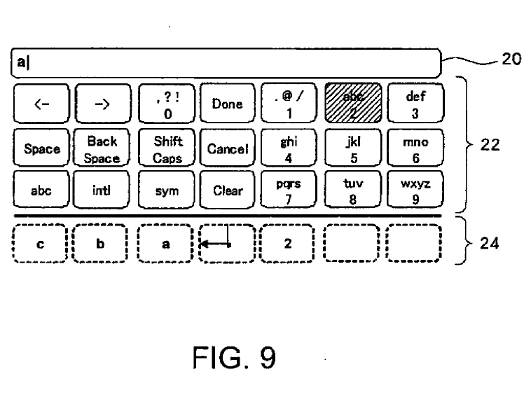

FIG. 5 shows the state of assignment of optional characters of the option section 24 achieved when the cursor is moved to the K-6 key of the key section 22. Optional characters of the K-6 key, namely, “c,” “b,” “a”, and “2” are assigned to the opt-3, the opt-2, the opt-1, and the opt-4, respectively. No character is assigned to the key 24a acting as the neutral key. When the center of the 5-way controller 14 is depressed in the state shown in FIG. 5; namely, the state where the cursor is situated at the K-6 key, the cursor moves from the key section 22 to the option section 24 and further moves to the neutral key 24a of the option section 24 as shown in FIG. 6. When the 5-way controller 14 is actuated right or left in the state shown in FIG. 6; namely, the state where the cursor is situated at the neutral key 24a of the option section 24, the cursor moves to the respective keys of the option section 24. For instance, when the 5-way controller 14 is actuated leftwardly, the cursor moves to the opt-1 key as shown in FIG. 7. When the character desired to be input by the user is “a,” the user depresses the center of the 5-way controller 14 while the cursor is situated at the opt-1 key, whereupon the character “a” is input to the string field 20. As shown in FIG. 8, the cursor automatically moves to the position of the neutral key 24a. When the user depresses the center of the 5-way controller 14 in the state shown in FIG. 8; namely, a state where the cursor is situated at the position of the neutral key 24a, the cursor moves from the option section 24 to the key section 22 as shown in FIG. 9. In the following, the cursor is likewise moved in the key section 22, and the center of the 5-way controller 14 is depressed, thereby moving the cursor to the neutral key 24a of the option section 24. The 5-way controller 14 is again actuated right or left, to thus select a desired character. The center of the 5-way controller 14 is depressed with the cursor being situated at the neutral key 24a, whereupon the cursor is rerned to the key section 22. When the character is selected in the option section 24, the cursor automatically moves to the neutral key 24a, and hence the user can retrn the cursor to the key section 22 by means of simple depressing operation without performing operation for actuating the 5-way controller 14 right or left. When the cursor moves from the key section 22 to the option section 24, the neutral key 24a is situated at the center of the option section 24, and the cursor is moved to the neutral key 24a. Thus, even when an arbitrary character of the option section 24 is selected, the number of operations required until the cursor reaches the respective characters can be leveled. Specifically, for instance, when the neutral key 24a is set to the opt-6 key at the right end, the user is required to perform operations only twice in the right direction in order to select the character “2” in FIG. 6; however, in order to select the character “c,” the user must perform six operations in the right direction, thus involving an increase in the number of operations. In the meantime, so long as the neutral key 24a is situated at the center as in the present embodiment, any character can be selected by a maximum of three operations, so that the number of operations can be reduced. The neural key 24a can be said to be set at a position where the cursor can reach all of selectable character groups by means of a minimum number of operations.

As a matter of course, optional characters assigned to the option section 24 are expected to differ from each other in terms of the frequency of selection. Hence, candidates for selection can also be assigned to keys located near the neutral key 24a in a descending sequence of possibility of selection from a high possibility to a low possibility. The frequency of selection can be acquired by sequentially accumulating the number of selections in memory. The essential requirement is to learn the frequency of selection and change the assignment of the keys of the option section 24. Alternatively, the frequency of selection may also be set by means of statistical analysis. For instance, the known fact is that a difference exists among characters of the alphabet in terms of the frequency of use. Consequently, when “a” is higher than “b” in terms of frequency of use, assigning “a” to the key near the neutral key is preferable. Fixing the position of the neutral key 24a to the center, and the position of a character or symbol to be assigned is dynamically changed according to the frequency of selection or use.

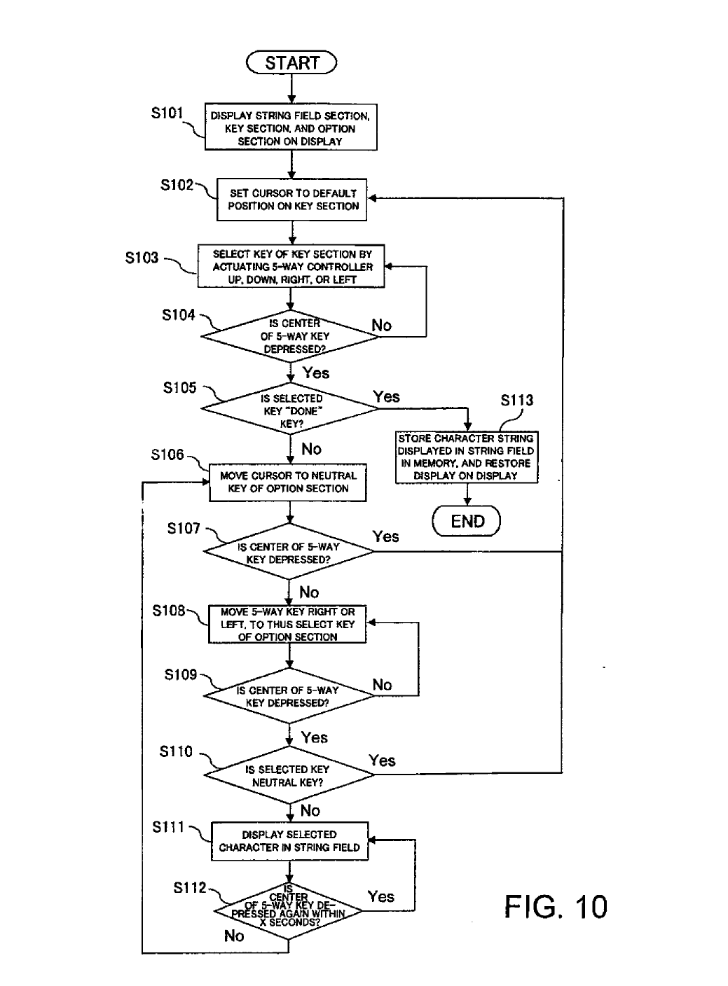

FIG. 10 shows a character input processing flowchart of the present embodiment. First, the control section 16 shows, on the display 12, the string field section 20, the key section 22, and the option section 24 as an initial state (S101). The cursor is located in the key section 22 and situated at a predetermined default key (S102). The predetermined default key is; for example, the K-1 key. In this state, the user actuates the 5-way controller 14 up, down, right, or left, thereby selecting a key (S103). The control section 16 receives an operation signal from the 5-way controller 14, and shows the cursor by moving the cursor up, down, right, or left, across the key section 22 in accordance with the operation signal. When the user has moved the cursor to a desired key and depressed the OK button; i.e., the center of the 5-way controller 14 (YES in S104), the control section 16 next determines whether or not the selected key is “Done” key (the K-4 key) (S105). When a determination is NO; namely, when the selected key is a key other than “Done” key (the K4 key), the cursor moves to the option section 24 and further moves to the position of the neutral key 24a acting as the default position (S106). The control section 16 determines whether or not the OK button; namely, the center of the 5-way controller 14, is depressed (S107). When the determination is YES; namely, when the center of the 5-way controller 14 is depressed, processing returns to S102, where the cursor again returns to the key at the default position in the key section 22. When the determination is NO, the user actuates the 5-way controller 14 right or left, to thus select the optional key (S108). When the user has moved the cursor to the desired optional key and depressed the OK button; i.e., the center of the 5-way controller 14 (YES in S109), a determination is made as to whether or not the selected optional key is the neutral key 24a (S110). When the detention is YES, processing returns to S102, where the cursor again returns to the key located at the default position in the key section 22. When the determination is NO, the control section 16 displays the selected character in the string field section 20 (S111). A determination is made as to whether or not the OK button; i.e., the center of the 5-way controller 14, is again depressed within X seconds (S112). When a result of determination is NO, the control section returns to S106, where the cursor is moved to the neutral key 24a of the option section 24. The reason for this is that when the same character is input incessantly, making an input again at that position without returning the cursor to the neutral key 24a is rational and, hence, a weight is applied for a given period of time X. The period of time X is, for example, 0.5 seconds or thereabouts. Thus, when the character belonging to the same key in the key section 22 is input incessantly, a character is selected and input in step S106 to S112. In contrast, when another different character in the key section 22 is input, processing returns to S102, and the key is operated. When inputting of the character is completed, a “Done” key (the K-4 key) of the key section 22 is selected in S103, and a determination rendered in S105 becomes YES. Information about a character string displayed in the string field section 20 is stored in predetermined memory, and inputting of the character is terminated. Thus, the display on the display 12 is restored to the original display (e.g., a mode for reviewing a captured image) (S113).

According to the present embodiment a cursor is moved by means of a smaller number of operations, to thus select a desired key and enable inputting of a desired character. In particular, when the cursor is moved from the key section 22 to the option section 24, the cursor is moved to the neutral position, thereby leveling the number of operations required to select an arbitrary optional character. Further, the cursor is automatically moved to the neutral position after selection of the optical character, whereby the cursor is readily returned from the option section 24 to the key section 22.

In the present embodiment, when the cursor moves from the key section 22 to the option section 24, the cursor is moved to the neutral key 24a of the option section 24. However, the cursor may also be moved to another key, for example, the opt-1 key. Even in this case, when the cursor returns from the option section 24 to the key section 22, the cursor returns from the position of the neutral key 24a. Moreover, when the cursor moves from the key section 22 to the option section 24, the cursor may also be moved to the position of an optional key having the highest frequency of selection among the optional keys. For example, when the character having the highest frequency of selection is assigned to the opt-1 key, the cursor is moved to the opt-1 key. When the user selects the character having the highest frequency of selection, the 5-way controller 14 does not need to be actuated right or left after movement of the cursor from the key section 22 to the option section 24, and a desired character can be selected by mere depressing operation. Even in this case, when the cursor returns from the option section 24 to the key section 22, the cursor returns from the position of the neutral key 24a. In order to return the cursor from the key assigned the character to the key section 22, operation other than depressing operation is required (depressing operation means selection of a character of interest). However, the neutral key is not assigned any character, and hence operation for depressing the neutral key enables returning of the cursor.

Although the embodiment of the present invention has been described by means of taking a digital camera as an example of the imaging device, the present invention can also be applied to a portable information terminal other than an imaging device, for example, a portable cellular phone.

### PARTS LIST

10 function section
12 display
14 controller
16 control section
20 string field section
22 key section
24 option section
24a neutral key
S101 initial state
S102 default position on key section
S103 selecting key by actuating 5-way controller
S104 center of 5-way key depressed?
S105 done key selected?
S106 neutral key of option section
S107 center of 5-way key depressed?
S108 select key of option center by moving 5-way key
S109 is center of 5-way key depressed?
S110 neutral key selected?
S111 display selected character in string field section
S112 is center of 5-way key depressed/
S113 store character string

What is claimed is:

1. An input device comprising:
a display having a first display section for displaying, in accordance with a first layout, a group of keys assigned a plurality of characters or symbols and a second display section for displaying, in accordance with a second layout, a group of optional keys which are each assigned one of the plurality of characters or symbols allocated to one arbitrary key of the group of keys;
operation means that can be operated by a user; and
control means for moving and displaying a cursor within the first display section or the second display section in accordance with an operation signal from the operation means, wherein
the second display section displays, in the group of optional keys, a neutral key not assigned the character or the symbol; and
the control means receives the operation signal from the operation means with the cursor being situated at the neutral key and moves and displays the cursor from the second display section to and on the first display section.

2. The input device according to claim 1, wherein, when an optional key other than the neutral key of the second display section is selected in accordance with the operation signal from the operation means, the control means moves and displays the cursor from the selected optional key to and on the neutral key.

3. The input device according to claim 1, wherein, when the cursor is moved and shown from an arbitrary key of the first display section to the second display section in accordance with the operation signal from the operation means, the control means moves and displays the cursor to and on the neutral key.

4. The input device according to claim 1, wherein the neutral key is placed in center of the group of optional keys.

5. The input device according to claim 1, wherein the neutral key is placed near a character or a symbol having the highest frequency of use among the characters or symbols.

6. The input device according to claim 1, wherein the first display section displays the group of keys in a matrix pattern; the second display section displays the group of optional keys in a row; and the operation means can be actuated in at least five directions including up, down, right, left, and depression.

7. An imaging device having the input device defined in claim 1.
